(19) United States
(12) Patent Application Publication
(10) Pub. No.: US 2010/0044909 A1
(43) Pub. Date: Feb. 25, 2010

(54) LOFTY, TACKIFIED NONWOVEN SHEET AND METHOD OF MAKING

(75) Inventors: Thomas E. Haskett, Oakdale, MN (US); Robert J. Maki, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/194,777

(22) Filed: Aug. 20, 2008

(51) Int. Cl. B29C 65/52; B29C 70/44

(52) U.S. Cl. 264/175; 264/258

(57) ABSTRACT

A method of making a tackified nonwoven sheet that includes forming a densified, tackified web by providing a rebulkable nonwoven fiber web and applying an adhesive to the nonwoven web. The densified, tackified web is rebulked to an open, lofty form by exposing the densified, tackified web to a temperature of at least 225° F. Finally, a sheet is formed from the rebulked, tackified web. In some embodiments, the so-formed sheet is a cleaning wipe configured for picking up diverse debris such as sand, dust, hair, and/or food particles. In other embodiments, the method further includes the rebulked, tackified web having an increased degree of loftiness as compared to a degree of loftiness of the densified, tackified web prior to rebulking.

### BACKGROUND

The present disclosure relates to adhesive-loaded, nonwoven fiber web-type sheet constructions and methods of manufacture. More particularly, it relates to nonwoven sheet constructions, such as cleaning wipes for removing diverse debris from surfaces, incorporating an adhesive and exhibiting enhanced loftiness, along with methods of making the same.

Adhesive-loaded, nonwoven sheet articles are commonly employed for a plethora of applications. For example, such articles can be used with filtration devices for filtering particles and/or odors from air. Additionally, adhesive nonwoven sheets can be provided as a cleaning wipe to clean debris from surfaces. As a point of reference, general cleaning wipe articles, or wipes, are used either by hand or attached to a tool such as a mop handle to move dirt, dust, etc. in a desired direction where an adhesive is incorporated into the wipe, the adhesive assists in retaining both small and large particles of dirt and other debris within the wipe structure. However, the adhesive may undesirably adhere to the surface being cleaned. Further, the adhesive may cause the wipe to overtly drag as the wipe is moved along the surface being cleaned.

Some efforts have been made to provide a cleaning wipe having a tacky or adhesive characteristic, yet with a lessened adhesive “feel” and surface drag. Such efforts have generally focused on the careful selection of the type and amount of the adhesive material(s), and/or the pattern of application of the adhesive as a means for reducing drag so as to improve particle pick-up while maintaining the ability of the cleaning wipe to glide across the surface being cleaned. While potentially viable, these techniques entail fairly complex machinery and process controls, and thus higher manufacturing costs. Further, the wipes resulting from such processing techniques are fairly dense. That is to say, the fibers of the adhesive-loaded nonwoven web are compacted relative to one another, thereby limiting the amount and/or size of particles that can be retained within the wipe's thickness.

In light of the above, a need exists for improved methods of making tackified, nonwoven fiber sheet products such as cleaning wipes. Further, a need exists for a low-cost, tackified, nonwoven fiber cleaning wipe exhibiting enhanced loftiness and low drag as compared to existing cleaning wipes.

### SUMMARY

Some aspects in accordance with principles of the present disclosure relate to a method of making a tackified nonwoven sheet. The method includes forming a densified, tackified web by providing a rebulkable nonwoven fiber web and applying an adhesive to the nonwoven web. The densified, tackified web is rebulked to an open, lofty form by exposing the densified, tackified web to a temperature of at least 225° F. Finally, a sheet is formed from the rebulked, tackified web. In some embodiments, the so-formed sheet is a cleaning wipe configured for picking up diverse debris such as sand, dust, hair, and/or food particles. In other embodiments, the method further includes the rebulked, tackified web having an increased degree of loftiness as compared to a degree of loftiness of the densified, tackified web prior to rebulking. In yet other embodiments, rebulking the densified, tackified web includes conveying a continuous length of the densified, tackified web through an oven heated to a temperature of at least 350° F. and at a conveyor speed of at least 5 feet per minute.

### BRIEF DESCRIPTION OF THE DRAWINGS

FIG. 1 is a schematic, perspective view of a tackified nonwoven sheet in accordance with the present disclosure;

FIG. 2 is a schematic illustration, with portions shown in block form, of a system and method in accordance with the present disclosure for making a tackified nonwoven sheet;

FIG. 3A is a simplified cross-sectional view of an example densified, tackified sheet provided at an intermediate stage of the system and method of FIG. 2; and

FIG. 3B is a simplified cross-sectional view of the sheet of FIG. 3A following rebulking by the system and method of FIG. 2, and as a rebulked, tackified sheet.

### DETAILED DESCRIPTION

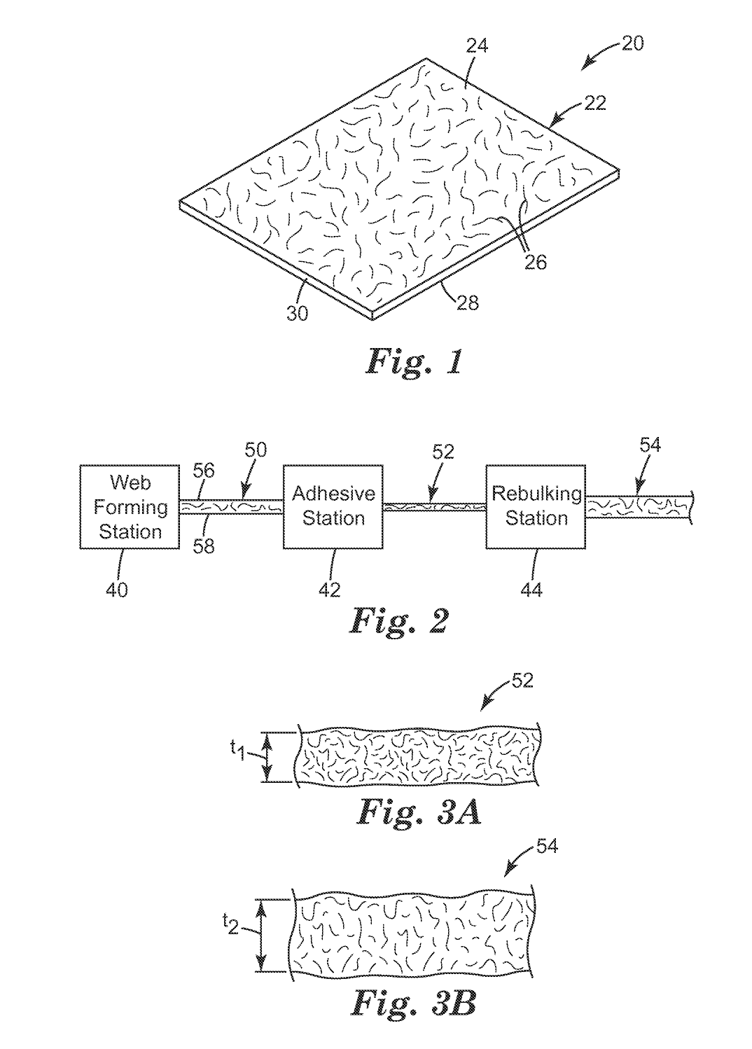

One embodiment of a sheet or wipe 20 in accordance with principles of the present disclosure is provided in FIG. 1. As a point of reference, the sheet 20 can be sized and/or shaped for various end-use applications, such as air filtration. In addition, the sheet 20 construction is highly useful for cleaning applications, and thus is interchangeably referred to as a “wipe” or “cleaning wipe” throughout this specification. In general terms, the cleaning wipe 20 includes a web construction 22 including a nonwoven fiber web 24 and an adhesive or tacky material (unnumbered in FIG. 1). The nonwoven fiber web 24 defines or forms a working surface 26 opposite a second surface 28 (with the second surface 28 being generally hidden in the view of FIG. 1). The term “working surface” is in reference to a side of the cleaning wipe 20 that is otherwise presented to and guided (or “wiped”) across a surface to be cleaned. An intermediate region 30 (referenced generally in FIG. 1) is defined between the outer surfaces 26, 28. With these designations in mind, the adhesive material coats individual fibers comprising the fiber web 24, providing a tackiness to the cleaning wipe 20. In this regard, the resultant web construction 22 exhibits a relatively high degree of loftiness as described below. For ease of illustration, the outer surfaces 26, 28 are shown in FIG. 1 as being substantially flat; it will be recognized that this representation does not reflect a void volume provided in embodiments of the present disclosure. Further, while the cleaning wipe 20 is shown in FIG. 1 as assuming a substantially planar form, other shapes are acceptable. For example, the cleaning wipe 20 can be rolled or folded onto itself to form a roll.

The term “degree of loftiness” as used in the specification is in reference to the spacing or “openness” of fibers otherwise forming the surface/area/volume in question. For example, a first surface/area/volume with fewer fibers per unit area or volume as compared to a second surface/area/volume comprised of the same denier fibers is considered to have a higher degree of loftiness. Alternatively, degree of loftiness can be defined in terms of bulk density. “Bulk density” is the weight of a given web per unit volume. The web thickness can be measured in many ways; one accurate method employs an optical scanning technique.

Various, acceptable material(s) and formats of the nonwoven fiber web 24 and the adhesive are provided below. More generally, the nonwoven web 24 is, in some embodiments, rebulkable. Rebulkable nonwoven webs may be converted (at least once) from a densified or compressed state (i.e., a higher density, lower soft state) to a rebulked or less compressed state (i.e., a lower density, higher soft state). The process of converting the rebulkable web from the densified state to the rebulked state is referred to as “rebulking.” Typically, the process of rebulking the web is accomplished by heating the web. Heating the web softens at least some of the bonds formed between fibers of the web. This allows at least some of the fibers to expand toward their original length, thereby at least partially restoring at least a portion of the original bulk to the nonwoven web. The adhesive applied to the nonwoven web 24 is selected to not overtly interfere with rebulking of the nonwoven web 24.

As described below, the web construction 22 includes the nonwoven web 24 in rebulked form and exhibits an elevated degree of loftiness relative to the type(s)/size(s) of fibers from which the nonwoven web 24 is constructed and a type and volume of an applied adhesive as compared to prior wipes incorporating similar materials. In some embodiments, these improvements are imparted via one or more of the methods of making disclosed herein. For example, FIG. 2 provides a simplified illustration of a process and system for making the cleaning wipe 20. The system includes a web forming station 40, an adhesive station 42, and a rebulking station 44. The stations 40-44 can assume a variety of forms and can be arranged to provide a continuous manufacturing process as shown, or one or more of the stations 40-44 can be provided separately such that processing from one station to another is discontinuous. Regardless, and in general terms, a rebulkable, nonwoven web 50 is generated at the web forming station 40. Adhesive is applied to the rebulkable nonwoven web 50 at the adhesive station 42. As part of the processing at the web forming station 40, the adhesive station 42 and/or at another station (not shown) “upstream” of the rebulking station 44, the rebulkable nonwoven web 50 is densified (e.g., compressed). As a result, a densified, tackified nonwoven web 52 exits from the adhesive station 42, and is then passed through the rebulking station 44 to effectuate rebulking of the densified, tackified web 52. A rebulked, tackified web 54 exits from the rebulking station 44, and can serve as the web construction 22 (FIG. 1), or can be further processed (e.g., cut) to form the desired wipe 20 (FIG. 1).

The web forming station 40 can include one or more devices typically used to form a nonwoven web from fibers. In general terms, however, the rebulkable nonwoven web 50 can be formed in a variety of fashions known in the art in which individual fibers are entangled with one another (and optionally bonded) in a desired fashion. For example, the rebulkable nonwoven web 50 can be formed by carding, spun bond, melt blown, air laid, wet laid, needle-tacking, etc. The rebulkable nonwoven web 50 can be consolidated by any known technique such as, for example, hydroentanglement, thermal bonding (e.g., calender or through air), chemical bonding, etc. Thus, the web forming station 40 can include two or more in-line sub-station components, such as (by way of but one non-limiting example) a combining sub-station at which loose fibers are combined together, a needle-tacking sub-station at which a web precursor is needle-tacked, and/or a melt-bonding sub-station at which the web precursor is melt-bonded.

In some embodiments, the selected web forming station 40 is further adapted to compress the formed rebulkable nonwoven web 50. This compression serves to densify the rebulkable nonwoven web 50. Thus, the web forming station 40 can include appropriate equipment for compressing the rebulkable nonwoven web 50 following carding, for calendering the nonwoven web 50, etc. For example, where the web forming station 40 is configured to form the rebulkable nonwoven web 50 via melt-bonding, compression of the web 50 can be effectuated by passing the rebulkable nonwoven web 50 between opposing belts that compress and density the rebulkable nonwoven web 50. The rebulkable nonwoven web 50 can be cooled in this state of compression to “set” the rebulkable nonwoven web 50 in its densified state. Regardless, the rebulkable nonwoven web 50 can be uniformly or non-uniformly densified at the web forming station 40. Even further, densification or compression of the rebulkable nonwoven web 50 can occur at the adhesive station 42 such that a compression sub-station component need not be included with the web forming station 40.

Where desired, the formed rebulkable nonwoven web 50 can be subjected to further processing prior to application of adhesive, such as printing indicia to one or both of the outer surfaces 56, 58 (e.g., trademark, user information, etc.), a colorant applied, a surface pattern imparted, etc. Even further, the rebulkable nonwoven web 50 can optionally be extrusion coated with plastic hooks for desired combination of properties.

Regardless of the resultant form or appearance of the rebulkable nonwoven web 50, an adhesive is applied to the web 50 at the adhesive station 42. Adhesive compositions useful with the present disclosure are described below. In general terms, however, the adhesive is, in some embodiments, a water-based pressure sensitive adhesive, and can be applied to the rebulkable nonwoven web 50 in a variety of fashions. For example, the adhesive can be roll-coated, pattern-coated, or one-side (or “kiss”) coated, spray-coated, screen-printed, etc. The volume of applied adhesive in combination with the application technique employed with the adhesive station 42 is selected, in some embodiments, to saturate the rebulkable nonwoven web 50. Alternatively, only partial saturation can be effectuated. With this alternative approach, the adhesive is applied to one of the surfaces 56, 58 (in some embodiments the surface 56 or 58 intended to serve as the working surface 26 (FIG. 1)) of the rebulkable nonwoven web 50 to better ensure existence of at least some adhesive at the working surface 26 to assist in collecting debris during use of the finally formed wipe.

Application of the adhesive at the adhesive station 42 may naturally cause the rebulkable nonwoven web 50 to partially densify (e.g., the collective weight of the adhesive may cause the rebulkable nonwoven web 50 to self-compress, the adhesive may cause individual fibers to more closely bond with one another, etc.). Under at least these circumstances, then, the web forming station 40 need not include a separate compression sub-station. Alternatively or additionally, the adhesive station 42 can include one or more devices for compressing and densifying the rebulkable nonwoven web 50.

Regardless of the manner in which the adhesive is applied, the densified, tackified web 52 is generated as shown in FIG. 2. As used in the specification, reference to a “densified, tackified web” is with respect to an intermediate stage of manufacture in which adhesive has been applied to a densified, rebulkable nonwoven web, but no additional manufacturing steps have been performed. For example, no additional web(s) are applied to the densified, tackified web 52; the densified, tackified web 52 is not folded onto itself; etc. With this in mind, the densified, tackified web 52 is rebulked at the rebulking station 44. More particularly, the densified, tackified web 52 is exposed or subjected to a heated environment having a temperature sufficient to promote re-lofting (or rebulking) of the densified, tackified web 52. Typically, the rebulking station 44 includes an oven. With water-based pressure sensitive adhesives, it has been found that temperatures of at least 225° F. cause desired rebulking (and drying) of the densified, tackified web 52.

The rebulking temperature can, in some embodiments, be greater than 225° F. For example, in some embodiments, the densified, tackified web 52 is subjected to, at the rebulking station 44, a temperature of at least 300° F., in other embodiments at least 325° F., in yet other embodiments at least 350° F. Further, the densified, tackified web 52 is, in some embodiments, continuously conveyed relative to the rebulking station 44. In other words, a continuous length of the densified, tackified web 52 is continuously conveyed through, for example, an oven. Though various other parameters may impact optional dwell times (e.g., oven length, temperature, ambient humidity, and percentage of solids of the adhesive) for causing rebulking and drying of the densified, tackified web 52, conveyor line speeds on the order of at least 5 feet per minute at oven temperatures of at least 225° F. are acceptable, although other processing speeds and/or temperatures can be employed.

In addition to effectuating an increase in the loftiness of the densified, tackified web 52, the rebulking step promotes a more uniform distribution of the applied adhesive to the fibers comprising the rebulkable nonwoven web 50. More particularly, as the fibers extend relative to one another with rebulking (thus establishing a greater spacing between adjacent fibers), the applied adhesive will naturally distribute itself in a relatively uniform manner throughout the interior of the nonwoven web 50 (i.e., the intermediate region 30 of FIG. 1). Alternatively, however, a less uniform adhesive distribution can also be accomplished by partially applying the adhesive to only one side 56 or 58 of the nonwoven web 50.

Following processing at the rebulking station 44, the rebulked, tackified web 54 results. Where desired, the rebulked, tackified web 54 can be subjected to further processing as desired. For example, the rebulked tackified web 54 can be patterned to a uniform geometry by an appropriate mechanism. Further, the rebulked, tackified web 54 can be cut to a desired size, shape, etc. Regardless, the cleaning wipe 20 (FIG. 1) is formed from the rebulked, tackified web 54 (that is otherwise akin to the web construction 22 of FIG. 1).

The enhanced loftiness effectuated by the above-described rebulking in the presence of heat can be characterized by referencing a degree of loftiness prior to and following rebulking. For example, and with reference to the schematic illustrations of FIGS. 3A and 3B, the densified, tackified web 52 has a thickness t₁. Upon exposing the densified, tackified web 52 to heat as described above, the resultant rebulked, tackified web 54 has a thickness t₂, with the rebulked thickness t₂ being greater than the thickness t₁ prior to rebulking by at least 10%.

The openness or loftiness achieved with the above-described methods of making are a function of the materials and amounts selected for the rebulkable nonwoven web 50 and the adhesive. For example, the size and/or weight of the selected fibers and/or the volume or composition of the applied adhesive will inherently affect the resultant loftiness achieved when subjecting the densified, tackified web 52 to the temperatures described above. With this in mind, the fibers comprising the rebulkable nonwoven web 50 (and thus of the nonwoven web 24 of FIG. 1) are synthetic or manufactured, but alternatively can include natural fibers. As used herein, the term “fiber” includes fibers of indefinite length (e.g., filaments) and fibers of discrete length (e.g., staple fibers). The fibers used in connection with the rebulkable nonwoven web 50 may be multicomponent fibers. The term “multicomponent fiber” refers to a fiber having at least two distinct longitudinally co-extensive structured polymeric domains in the fiber cross-section, as opposed to blends where the domains tend to be dispersed, random, or unstructured. In some embodiments, two or more differing types of fibers are employed (e.g., a multiplicity of a first fiber and a multiplicity of a second fiber). Regardless, useful fibrous materials include, for example, polyesters, polyamides, polyimides, nylon, polyolefins (e.g., polypropylene and polyurethane), rayon, melty fiber, etc., of any appropriate fiber length and denier, and mixtures thereof. Further, some or all of the fibers can have special treatments to enhance hydrophilic properties, such as additives including super-absorbing gel polymers; also, powder(s) or fiber(s) such as, but not limited to, rayon, cotton, and cellulose, can be added to enhance liquid-holding capacity.

Small denier size staple fibers (e.g., 3 d-15 d) provide the resultant nonwoven web 24 (FIG. 1) with smaller pore sizes and more surface areas compared to a fiber web made with larger denier fibers (e.g., 20 d-200 d) that otherwise provides the nonwoven web 24 with larger pore sizes and less surface area. The small denier fiber webs are best suited for cleaning surfaces contaminated with fine dust and dirt particles, whereas the large denier fiber webs are best suited for cleaning surfaces contaminated with larger dirt particles such as sand, food crumbs, lawn debris, etc. The larger pore sizes of the larger denier staple fibers allow the larger contaminant particles to enter, and be retained by, the matrix of the fiber web. The nonwoven web 24 of the present disclosure can include one or both of the small and/or large denier fibers that may or may not be staple fibers. In some embodiments, the nonwoven web 24 includes crimped, high heat distortion fibers. Preferably, however, to ensure desired loftiness, a majority of the fibers of the nonwoven web 24 are of a larger denier (e.g., at least 20 denier, more preferably at least 25 denier).

The adhesive can also assume a variety of forms, and in some embodiments, is or includes a water-based pressure sensitive adhesive. Pressure sensitive adhesives are normally tacky at room temperature and can be adhered to a variety of surfaces by application of light finger pressure. An adhesive bond is developed by pressing a second surface (or individual particles of a second material such as, for example, dust, dirt, crumbs, or other debris) against the pressure sensitive adhesive coated material. Alternatively, suitable adhesives for use with the present disclosure include any that are capable of being tacky at room temperature, including both adhesives that are initially tacky and those that are initially non-tacky but which can be activated to become tacky. Suitable adhesives include any pressure sensitive adhesives including materials based on acrylates, silicones, poly-alpha-olefins, polyisobutylenes, rubber block copolymers (such as styrene/isoprene/styrene and styrene/butadiene/styrene block copolymers, styrene/butadiene/rubbers, synthetic isoprenes, natural rubber, and blends thereof). While the pressure sensitive adhesives useful with the present disclosure are preferably water based, in other embodiments, the pressure sensitive adhesives may be coated from solvents, radiation polymerized, or hot melt processed. These pressure sensitive adhesives may or may not be cross-linked. Cross-linking can be done by well-known methods, including chemical, ionic, physical, or radiation-induced processes. Other useful adhesive compositions may include, for example, polyvinyl ethers, ethylene containing copolymers such as ethylene vinyl acetate, ethylacrylate, and ethylmethacrylate, polyurethanes, polyamides, polyepoxides, polyvinylpyrrolidones, and copolymers thereof, polyvinyl alcohols, and copolymers thereof, polyesters, and combinations thereof.

A general description of useful pressure sensitive adhesive compositions can be found in the Encyclopedia of Polymer Science and Engineering, Volume 13, Wiley-Interscience Publishers (New York 1988). As discussed in the Handbook of Pressure Sensitive Adhesive Technology, Second Edition (D. Satas, Editor Van Nostrin Reinhold, New York, 1989), these adhesives may be based on polymers like natural rubber, acrylates, styrene-budadienes, and vinyl ethers. Further, the elastomeric block copolymers of the adhesive composition may be formulated with tackifying resins (tackifiers) to improve adhesion and introduce tack into the pressure sensitive adhesive.

Suitable tackifier resins are described in the Handbook of Pressure Sensitive Adhesive Technology referenced above, and can include rosin esters, terpenes, phenols, and aliphatic, aromatic, or mixtures of aliphatic and aromatic synthetic hydrocarbon monomer resins. The tackifier components useful in block copolymer adhesive compositions can be solid, liquid, or a blend thereof. Suitable solid tackifiers include rosin, rosin derivatives, hydrocarbon resins, polyterpenes, coumarone indenes and combinations thereof. Suitable liquid tackifiers include liquid hydrocarbon resins, hydrogenated liquid polystyrene resins, liquid polyterpenes, liquid rosin esters, and combinations thereof. Many tackifiers are commercially available, and optimum selection thereof can be accomplished by one of ordinary skill in the adhesive compounding art.

The adhesive composition can also include additives such as, for example, plasticizers, diluents, fillers, antioxidants, stabilizers, pigments, cross-linking agents, and the like.

The amount of adhesive that is applied to the rebulkable nonwoven web 50 depends on a number of factors, including the tackiness of the adhesive, the degree to which the adhesive adheres to surfaces (and thus makes wiping difficult), and other such factors. In some embodiments, the amount of adhesive should be sufficient enough for the resultant wipe 20 (FIG. 1) to capture both small and large particles of various shapes and consistencies, such as lint, dust, hair, sand, food particles, and the like, without having excess adhesive that could create drag and make wiping difficult and/or that could be transferred to the surface being cleaned. With this in mind, the wipe constructions in accordance with the present disclosure will typically include from about 5 weight % to about 200 weight % of adhesive, more typically from about 10 weight % up to about 130 weight %.

Due to the enhanced loftiness and uniform adhesive distribution provided by the above methods, the resultant wipe 20 can incorporate an increased adhesive loading as compared to existing adhesive laden, nonwoven wipes. As a result, the cleaning wipe 20 more readily retains debris as compared to wipes of similar construction/materials. Further, due to the enhanced loftiness, a greater volume of debris can be retained, while at the same time exhibiting a reduced drag value. With any of the above-described methods, by varying one or more the tacky material type and/or basis weight, fiber denier and/or basis weight, temperature, line speed, etc., the resultant cleaning wipe 20 can be formed to provide certain desired characteristics. Further, multiple ones of the so-formed cleaning wipes 20 can be releasably secured to one another in a back-to-back fashion (such as by an appropriate adhesive or other tacky material). With this configuration, individual cleaning wipes can be successfully stripped from a multiple layer assembly before, during, or after use in cleaning. Regardless, methods of the present disclosure provide marked improvements over previous designs by generating a lofty, tackified cleaning wipe in a simple and rapid manner highly amenable to mass production.

### EXAMPLES

Features and advantages of the present disclosure are further illustrated in the following Examples. It is to be expressly understood, however, that the particular materials and amounts used, as well as other conditions and details are not to be construed in a manner that would unduly limit the scope of this disclosure.

### Example No. 1

An example cleaning wipe was prepared in accordance with aspects of the present disclosure by first providing a fiber blend consisting of (1) 50% (weight percent) 15 denier×2.0 inch polyester staple fiber (available under the trade designation KoSa T-295 from Invista of Charlotte, N.C.), (2) 30% (weight percent) 25 denier×1.5 inch polyester staple fiber (available under the trade designation 694 P from Wellman, Inc., of Fort Mill, S.C.), and (3) 20% (weight percent) 4 denier×2 inch polyester melty staple fiber (available under the trade designation LMF from Huvis of Seoul, Korea). The fiber blend was carded to a basis weight of 54 gsm. The carded web was then calendered on a calender device having two smooth steel rolls. The rolls were heated to 245° F., and set to a gap of 0.020 inch. The calender device was run at a calender pressure of 100 psi, and employed to pre-bond the web.

A liquid adhesive composition consisting of a liquid acrylic adhesive at 17.5% solids (available under the trade designation RD-914 from 3M Company of St. Paul, Minn.), 0.5% surfactant (available under the trade designation OT-75 from Union Carbide of Danbury, Conn.), and 0.1% defoamer agent (available under the trade designation Advantage Defoamer 1512 from Hercules, Inc. of Wilmington, Del.) was prepared. The adhesive composition was roll coated to the calendered web by a roll coater having a steel gravure bottom roll and a rubber top roll, maintained at a nip pressure of 60 psi. The web was roll coated to saturation. Following application of the adhesive composition, the coated web was re-bulked and dried in a through air oven set at a temperature of 400° F. and at a typical line speed of 20 feet per minute. The re-bulked web was then collected on a surface winder for subsequent formation as a cleaning wipe (e.g., cutting operation), and had a finish weight after drying of 70 gsm.

### Example No. 2

A 60 gsm basis weight carded web available from Precision Custom Coatings, LLC, of Totowa, N.J. was provided, using the same fiber blends and denier sizes (30% 25 denier PET, 50% 15 denier PET, & 20% 4 denier PET Melty), but different manufacturers of Example No. 1 above. The web was carded, through air bonded, and compressed in one step. In a second step a liquid adhesive composition consisting of 20% solids RD -914 (available from 3M Company of St. Paul, Minn.), 0.5% OT-75 surfactant (available from Union Carbide of Danbury, Conn.), and 0.1% 1512 defoamer (available from Hercules of Wilmington, Del.) was prepared and roll coated to the carded web. The coated cloth was rebulked and dried in an oven as was Example 1. The dried coated cloth weight was 70 gsm.

The re-bulked, tackified webs and wipes of Example Nos. 1 and 2 exhibited sufficient web openness for dust holding capacity, low drag, and good re-bulking or lofting in the drying oven.

The re-bulked, tackified webs and wipes of Example Nos. 1 and 2 were subjected to testing as described below, as was a Comparative Example in the form of a dry floor cloth available from 3M Company under the trade name 3M Super Cling Dry Floor Cloth, Catalog No. 8001. The webs and wipes as tested had weights and caliper characteristics as set forth in Table 1 below.

TABLE 1

| | Basis Wt. | Adhesive | Total Wt. | Caliper | Caliper |
|---|---|---|---|---|---|
| Sample | (gsm) | Wt. (gsm) | (gsm) | (in) | (mm) |
| Example 1 | 54 | 14 | 68 | 0.125 | 3.18 |
| Example 2 | 60.0 | 9.5 | 69.7 | 0.113 | 2.87 |
| Comparative | 61 | 5 | 66 | 0.062 | 1.58 |
| Example | | | | | |

### Test Methods

### Drag Measurement

A model 225-235 Friction Tester, available from Thwing-Albert Instrument Company (Philadelphia, Pa.), was equipped with a 500 lb load plate (3 inch×5 inch), and set to a speed of 110 inch (279.4 cm) per minute and a time of 5 seconds. A rectangular sheet of black glass was cut to fit the Friction Tester, and marked with a 4 inch long test area. The glass was cleaned using glass cleaner. Individual test samples were prepared as 6 inch×8 inch sections of the wipe to be tested, folded in half (4 inch×6 inch surface area), and placed on the test fixture. The friction tester was run, and the kinetic coefficient of friction (KI) and static coefficient of friction (ST) values were recorded.

### Sand and Dust Removal Test—Flat

Sand and dust removal was measured by distributing a mixture of 0.5 gram sand (90-177 micron mean diameter) and 0.15 gram JIS dust (with a combined weight of the sand and dust collectively designated as W₁) on the surface of a 1.33 meter square floor. A test sample cloth was weighed and recorded (W₂), and then attached to a flat head of a mop available from 3M Company of St. Paul, Minn. (ScotchBrite™ High Performance Sweeper Mop). The mop head was attached to the mop handle. The test sample was first pushed and pulled once over the entire flooring area (i.e., one pass over every area of the flooring that had sand and dust on it) with minimal pressure applied to the handle of the mop, and then pushed around the edge of the flooring area in a counter-clockwise motion, turning the mop head at the corners. The test sample cloth was then carefully removed from the handle and its weight was measured (W₃). The weight percent of the sand and dust removed by the test sample from the surface was calculated as follows:

% sand and dust removed=[(W₃−W₂)/W₁]×100.

### Hair Removal Test—Flat

Hair removal was measured in accordance with the Sand and Dust Removal Test—Flat, except that 0.2 gram of pet hair (W₁) was distributed onto the flooring area rather than sand and dust.

### Sand and Dust Removal Test—Contour

Sand and dust removal was measured according to the Sand and Dust Removal Test—Flat except that the wipe samples were attached to a contour or angle glider head rather than a flat mop head. The contour head has a triangular-like shape, thus providing three edges for cleaning. The contour head is described in U.S. application Ser. No. 11/953,542, filed Dec. 10, 2007, and entitled “Cleaning Tool” and the entire teachings of which are incorporated herein by reference. Further, the combination of sand and hair distributed onto the flooring area was 0.8 gram sand (90-177 micron mean diameter) and 0.2 gram JIS dust, and three allotments of the sand and hair combination were prepared. The testing consisted of distributing a first allotment of the sand and hair combination onto the flooring area, passing the test sample along the first edge of the head over the flooring area as described in the Sand and Dust Removal Test—Flat, and repeating the procedure for the second and third allotments along the second and third edges of the head, respectively (e.g., distributing a second allotment of the sand and hair combination onto the flooring area, passing the test sample along the second edge of the head over the flooring area, etc.). The test sample was thus exposed to a total of 3.0 grams sand and dust (W₁), and the test sample was weighed (W₃) after the third pass.

### Hair Removal Test—Contour

Hair removal was measured according to the Sand and Dust Removal Test—Contour, except that three allotments of 0.3 gram pet hair were prepared and distributed onto the flooring area in succession, exposing the test sample to 0.9 gram pet hair in total (W₁).

### Sand Removal Test A—Contour

Sand removal was measured according to the Sand and Dust Removal Test—Contour except that three allotments of 1.0 gram sand (90-177 micron mean diameter), rather than a combination of sand and hair, were prepared and distributed onto the flooring area in succession, exposing the test sample to 3.0 grams sand in total (W₁).

### Sand Removal Test B—Contour

Sand removal was measured according to the Sand and Dust Removal Test—Contour except that three allotments of 2.0 grams sand (90-177 micron mean diameter), rather than a combination of sand and hair, were prepared and distributed onto the flooring area in succession, exposing the test sample to 6.0 grams sand in total (W₁).

### Sand Removal Test C—Contour

Sand removal was measured according to Sand and Dust Removal Test—Contour except that three allotments of 3.0 grams sand (90-177 micron mean diameter), rather than a combination of sand and hair, were prepared and distributed onto the flooring area in succession, exposing the test sample to 9.0 grams sand in total (W₁).

### Dust Removal Test—Contour

Dust removal was measured according to the Sand and Dust Removal Test—Contour, except that three allotments of 0.67 gram JIS dust, rather than a combination of sand and hair, were prepared and distributed onto the flooring area in succession, exposing the test sample to 2.0 grams JIS dust in total (W₁).

### Large Particulate Removal Test—Contour

Large particulate removal was measured according to the Sand and Dust Removal Test—Contour, except that three allotments of 0.25 gram crushed Cheerios™, rather than a combination of sand and hair, were prepared and distributed onto the flooring area in succession, exposing the test sample to 0.75 gram crushed Cheerios in total (W₁).

The measured drag coefficient of friction for Example Nos. 1 and 2 and the Comparative Example are provided in Table 2 below.

TABLE 2

| | Static Coefficient | |
|---|---|---|
| Sample | of Friction | Kinetic Coefficient of Friction |
| Example 1 | 0.793 | 0.563 |
| Example 2 | 0.642 | 0.470 |
| Comparative Example | 0.631 | 0.500 |

The results of the Sand and Dust Removal Test—Flat and the Hair Removal Test—Flat are provided in Table 3 below.

TABLE 3

| | % Sand & Dust Removal | |
|---|---|---|
| Sample | (Flat) | % Hair Removal (Flat) |
| Example 1 | 93.83 | 68.18 |
| Example 2 | 95.11 | 73.99 |
| Comparative Example | 66.02 | 65.31 |

Results of the various removal tests using the contour glider head are provided in Table 4 below.

TABLE 4

| | | % | | % Sand | | | |
|---|---|---|---|---|---|---|---|
| | % Hair | Particulate | % Dust | & Dust | % Sand | % Sand | % Sand |
| | Removal | Removal | Removal | Removal | Removal A | Removal B | Removal C |
| Sample | (Contour) | (Contour) | (Contour) | (Contour) | (Contour) | (Contour) | (Contour) |
| Example 1 | 85 | 87 | 58 | 88 | 98 | 98 | 92.3 |
| Example 2 | 77.6 | 68.6 | 61.0 | 88.1 | 98.8 | 97.8 | 89.0 |
| Comparative | 44.4 | 52.0 | 21.8 | 48.8 | 36.0 | 38.0 | 31.1 |
| Example | | | | | | | |

Comparison of performance between Example Nos. 1 and 2 and the Comparative Example showed that the presence of adhesive has a large effect on debris removal with minimal effect on drag.

Although the present disclosure has been described with reference to preferred embodiments, workers skilled in the art will recognize that changes can be made in form and detail without departing from the spirit and scope of the present disclosure.

1. A method of making a tackified nonwoven sheet, the method comprising:
forming a single-layer densified, tackified web including:
providing a rebulkable nonwoven fiber web,
applying an adhesive to the single-layer rebulkable nonwoven web;
rebulking the densified, tackified web by exposing the single-layer densified, tackified web to a temperature of at least 225° F. to generate a single-layer rebulked, tackified web having an open, lofty form; and
forming a cleaning wipe from the single-layer rebulked, tackified web.

2. The method of claim 1, wherein the densified, tackified web has a first thickness and the rebulked, tackified web has a second thickness, the second thickness being greater than the first thickness.

3. The method of claim 1, wherein the densified, tackified web has a first degree of loftiness, and the rebulked, tackified web has a second degree of loftiness, the second degree of loftiness being greater than the first degree of loftiness.

4. The method of claim 1, wherein the densified, tackified web has a first average spacing between adjacent fibers and the rebulked, tackified web has a second average spacing between adjacent fibers, the second average spacing between adjacent fibers being greater than the first average spacing between adjacent fibers.

5. The method of claim 1, wherein providing a rebulkable nonwoven fiber web includes:
entangling a plurality of fibers; and
compressing the entangled fibers.

6. The method of claim 5, wherein the rebulkable nonwoven fiber web has a first thickness following compressing, and the rebulked, tackified web has a second thickness, the second thickness being greater than the first thickness.

7. The method of claim 1, wherein compressing the entangled fibers includes:
calendering the entangled fibers.

8. The method of claim 1, wherein applying an adhesive includes:
applying a water-based pressure sensitive adhesive composition to the nonwoven fiber web.

9. The method of claim 8, wherein the pressure sensitive adhesive composition includes at least 25% water and an acrylate adhesive.

10. The method of claim 1, wherein the method includes the absence of applying a compressive force to the tackified web immediately after the step of applying the adhesive and prior to the step of rebulking the densified, tackified web.

11. The method of claim 1, wherein rebulking the densified, tackified web includes exposing the densified, tackified web to a temperature of at least 350° F.

12. The method of claim 1, wherein conveying a continuous length of the densified, tackified web includes moving the tackified web through the oven at a conveyor speed of at least 5 feet per minute.

13. The method of claim 1, wherein rebulking the densified, tackified web includes conveying a continuous length of the densified, tackified web through an oven heated to a temperature of at least 300° F.

14. The method of claim 13, wherein the oven is heated to a temperature of at least 350° F.

15. A method of making a tackified nonwoven sheet, the method comprising:
forming a densified, tackified web including:
providing a rebulkable nonwoven fiber web,
applying an adhesive to the rebulkable nonwoven web;
rebulking the densified, tackified web by exposing the densified, tackified web to a temperature of at least 225° F. to generate a rebulked, tackified web having an open, lofty form; and
forming a cleaning wipe from the rebulked, tackified web,
wherein there is an absence of applying a compressive force to the tackified web immediately after the step of applying the adhesive and prior to the step of rebulking the densified, tackified web.

16. The method of claim 15, wherein at least some of the adhesive is exposed at a working surface of the cleaning wipe.

17. The method of claim 15, wherein there is an absence of additional densified, tackified webs applied to the densified, tackified web.

18. The method of claim 15, wherein the densified, tackified web is a single layer web.
